(19) United States
(12) Patent Application Publication
(10) Pub. No.: US 2021/0035506 A1
(43) Pub. Date: Feb. 4, 2021

(54) BACKLIGHT CONTROL METHOD FOR MOTION BLUR REDUCTION, BACKLIGHT MODULE AND DISPLAY APPARATUS USING THE SAME

(71) Applicant: Novatek Microelectronics Corp., Hsinchu (TW)

(72) Inventors: Hongchun Cong, Xi'an City (CN); YuanJia Du, Shandong Province (CN)

(73) Assignee: Novatek Microelectronics Corp., Hsinchu (TW)

(21) Appl. No.: 16/524,170

(22) Filed: Jul. 29, 2019

(51) Int. Cl. G09G 3/34; G09G 3/36

(52) U.S. Cl. CPC G09G 3/342; G09G 3/36; G09G 2320/0233; G09G 2320/0653; G09G 2330/021; G09G 2360/16

(57) ABSTRACT

The disclosure provides a backlight control method for motion blur reduction, a backlight module and a display apparatus using the same. The backlight control method includes the following steps. An input frame including image blocks is received. A brightness level of each of the image blocks is determined to accordingly determine a local dimming value of each backlight block, where the backlight blocks respectively correspond to the image blocks. A boosted backlight value and a dimmed backlight value for each of the backlight blocks are computed according to the local dimming values. The backlight blocks are driven according to the boosted backlight values and the dimmed backlight values in a time sequence.

### TECHNICAL FIELD

The disclosure relates to a backlight control technique for motion blur reduction.

### BACKGROUND

In the fiercely competitive electronic industry, motion blur has been a severe problem for LCD displays due to their sample-and-hold nature. The existing approaches for removing such motion blur include reduction in LCD response time, black frame insertion, and backlight blinking technology. The algorithm of reduction in LCD response time could only reduce the motion blur as much as possible, and yet the motion blur could not be completely mitigated due to the hold-on characteristic of LCD displays. Therefore, LCD responses would be still detectable by human vision. The algorithm of black frame insertion would bring about problems such as frame rate reduction as well as brightness reduction. The backlight blinking technology could hide the response time of liquid crystal by backlight flicker. The advantage of blinking is that there would be no frame rate degradation, and yet the problem of brightness degradation would still exist.

### SUMMARY OF THE DISCLOSURE

A backlight control method for motion blur reduction, a backlight module and a display apparatus using the same are proposed.

According to one of the exemplary embodiments, the method includes the following steps. An input frame including image blocks is received. A brightness level of each of the image blocks is determined to accordingly determine a local dimming value of each backlight block, where the backlight blocks respectively correspond to the image blocks. A boosted backlight value and a dimmed backlight value for each of the backlight blocks are computed according to the local dimming values. The backlight blocks are driven according to the boosted backlight values and the dimmed backlight values in a time sequence.

According to one of the exemplary embodiments, the backlight module includes a light source, a control circuit, and a driving circuit. The light source includes backlight blocks. The control circuit is configured to receive an input frame including image blocks respectively corresponding to the backlight blocks, determine brightness level of each of the image blocks to accordingly determine a local dimming value of each of the backlight blocks, and compute a boosted backlight value and a dimmed backlight value for each of the backlight blocks according to the local dimming values. The driving circuit is configured to drive the backlight blocks according to the boosted backlight values and the dimmed backlight values in a time sequence.

According to one of the exemplary embodiments, the display apparatus includes a display panel and a backlight module coupled thereto. The backlight module includes a light source, a control circuit, and a driving circuit. The light source includes backlight blocks. The control circuit is configured to receive an input frame including image blocks respectively corresponding to the backlight blocks, determine brightness level of each of the image blocks to accordingly determine a local dimming value of each of the backlight blocks, and compute a boosted backlight value and a dimmed backlight value for each of the backlight blocks according to the local dimming values. The driving circuit is configured to drive the backlight blocks to project light onto the display panel according to the boosted backlight values and the dimmed backlight values in a time sequence.

In order to make the aforementioned features and advantages of the present disclosure comprehensible, preferred embodiments accompanied with figures are described in detail below. It is to be understood that both the foregoing general description and the following detailed description are exemplary, and are intended to provide further explanation of the disclosure as claimed.

It should be understood, however, that this summary may not contain all of the aspect and embodiments of the present disclosure and is therefore not meant to be limiting or restrictive in any manner. Also the present disclosure would include improvements and modifications which are obvious to one skilled in the art.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 illustrates a schematic diagram of a proposed display apparatus in accordance with one of the exemplary embodiments of the disclosure.

FIG. 2 illustrates a flowchart of a backlight control method in accordance with one of the exemplary embodiments of the disclosure.

FIG. 3 illustrates a functional block diagram of a backlight control method in accordance with one of the exemplary embodiments of the disclosure.

FIG. 4 illustrates a schematic diagram of a result of a backlight control method in accordance with one of the exemplary embodiments of the disclosure.

To make the above features and advantages of the application more comprehensible, several embodiments accompanied with drawings are described in detail as follows.

### DESCRIPTION OF THE EMBODIMENTS

Some embodiments of the disclosure will now be described more fully hereinafter with reference to the accompanying drawings, in which some, but not all embodiments of the application are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout.

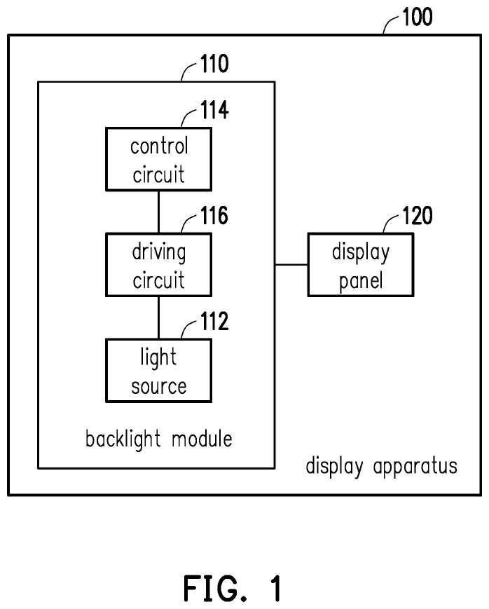

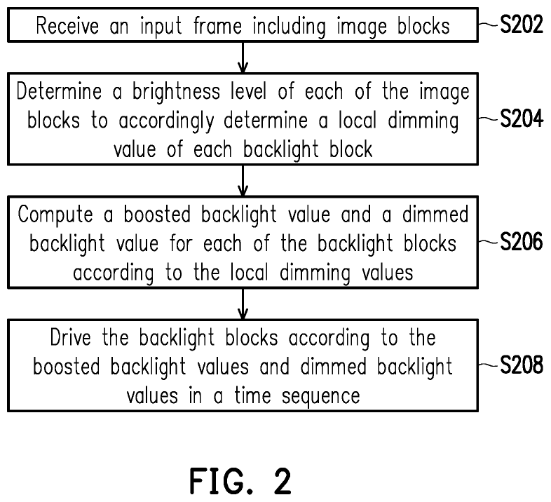

FIG. 1 illustrates a schematic diagram of a proposed display apparatus in accordance with one of the exemplary embodiments of the disclosure. All components of the display apparatus and their configurations are first introduced in FIG. 1. The functionalities of the components are disclosed in more detail in conjunction with FIG. 2.

Referring to FIG. 1, a display apparatus 100 would include a backlight module 110 and a display panel 120 coupled thereto. The backlight module 110 would include a light source 112, a control circuit 114, and a driving circuit 116. The light source 112 would be formed in blocks (referred to as “backlight blocks”) for projecting light onto the display panel 120. The light source 112 may be composed by, for example, cold cathode fluorescent lamps (CCFLs) or light-emitting diodes (LEDs). The control circuit 114 would be configured to control the operation of the backlight module 110. The driving circuit 116 would be configured to drive the light source 112 to project light onto the display panel 120 based on backlight control signals issued by the control circuit 114. The display panel 120 would be configured to display image frames and may be an LCD display panel, an OLED display panel, and so forth.

FIG. 2 illustrates a flowchart of a backlight control method in accordance with one of the exemplary embodiments of the disclosure. The steps of FIG. 2 may be implemented by the proposed display apparatus 100 as illustrated in FIG. 1.

Referring to FIG. 2 in conjunction to FIG. 1, the control circuit 114 of the backlight module 110 of the display apparatus 100 would receive an input frame including image blocks

(Step S202). Herein, the input frame would include an array of image pixels. Each image pixel would have a pixel value such as an RGB value that would represent the brightness. Each of the image blocks in the frame would have a one-to-one correspondence relation with each of the backlight blocks respectively.

Note that local dimming may dim backlight brightness in a dark area of an image frame to save backlight power consumption. In the present exemplary embodiment, the saved power consumption may be used for backlight boosting. Hence, the control circuit 114 would determine a brightness level of each of the image blocks to accordingly determine a local dimming value of each backlight block (Step S204). In detail, for each of the image blocks, the control circuit 114 may compute the brightness level based on the pixel values of the pixels in the image block and determine the local dimming value of the backlight block corresponding to the image block, where the brightness level may be statistical information of the pixel values within the block such as the mean, the maximum, the median, and so forth. In one exemplary embodiment, the local dimming value of each of the backlight blocks may be a weighted sum of different pieces of the statistical information of the pixel values in the corresponding image block such as Eq. (1)

Bal=w₁×Max+w₂×Mean+w₃×Max95

where Max denotes the maximum pixel value within the image block, Mean denotes the mean of the pixel values within the image block, Max95 denotes the pixel value at 95 percentile within the image block, and where w₁, w₂, and w₃ denote the weights which may be constants or dynamic variables changing with an image scene.

In order to hide a response time of the display panel 120 by the backlight blinking approach, the backlight would need to be separated into two parts in temporal. During a first time period, the backlight may be turned on, and during a second time period, the backlight may be almost turned off. Since the brightness would decrease when the backlight is almost turned off, the backlight would be boosted to compensate for the brightness loss when the backlight is turned on.

Herein, the control circuit 114 would compute a boosted backlight value and a dimmed backlight value for each of the backlight blocks according to the local dimming values (Step S206), and the driving circuit 114 would drive the backlight blocks according to the boosted backlight values and the dimmed backlight values in a time sequence (Step S208). In other words, for each of the backlight block, the control circuit 114 would compute the boosted backlight value of the backlight block by boosting the corresponding local dimming value and compute the dimmed backlight value for each of the backlight block by lowering the corresponding local dimming value. Also, for each of the backlight blocks, the control circuit 114 would receive the first time period and the second time period respectively corresponding to the boosted backlight value and the dimmed backlight value from a memory circuit (not shown), where the sum of the first time period and the second time period would be a frame display time of the frame. In another exemplary embodiment, the first time period and the second time period may be designated by the control circuit 114. The driving circuit 114 would drive the backlight block with the boosted backlight value for the first time period followed by the dimmed backlight value for the second time period.

Note that in order to maintain the brightness, the following condition as shown in Eq. (2) would be satisfied for each of the backlight blocks:

Bal×T=Bal_{bos}×T_{bos}+Bal_{dim}×T_{dim}

T=T_{bos}+T_{dim}

where Bal denotes the local dimming value, T denotes the frame display time of one frame, Bal_{bos} denotes the boosted backlight value, T_{bos} denotes the time when the boosted backlight is active (i.e. the aforesaid first time period), Bal_{dim} denotes the dimmed backlight value, and T_{dim} denotes the time when the dimmed backlight is active (i.e. the aforesaid second time period). Note that T_{bos}=T_{dim} or T_{bos}<T_{dim}(e.g. T_{bos}=0.25 T and T_{dim}=0.75 T).

The motion blur is a well-known issue specially for LCD displays due to liquid crystal unable to change its orientation and transmission rapidly enough from one frame to the next. Therefore, in one exemplary embodiment, prior to Step 5208, the control circuit 114 may obtain a display response time according to characteristics of the display panel 120, and this may be a predetermined value that has been estimated and stored in the memory circuit. Next, the control circuit 114 would control the driving circuit 116 to drive the backlight block with the boosted backlight value for the first time period following a delay time associated with the display response time so that the backlight would be accurately aligned with (i.e. synchronized with) the displayed frame to reduce motion blur.

In the present exemplary embodiment, by combining the backlight blinking technology with the backlight local dimming and boosting, the motion blur of the display panel 120 would be removed without brightness loss. The brightness loss due to the backlight blinking technology would be compensated by using backlight boosting, which would require higher power to maintain high brightness. The problem of power consumption would be solved by local dimming. The backlight blinking technology with backlight dimming and boosting would reduce the motion blur problem especially for LCD displays and minimize the brightness drop as much as possible. For a display panel that does not support backlight boosting, when such function is turned on, moving objects become clearer and brightness does not decrease in dark scenes, and the clearness of moving objects decreases while the brightness does not decrease in bright scenes. For a display panel that supports backlight boosting, moving scenes would be clearly observed in bright and dark scenes, and the brightness would not decrease.

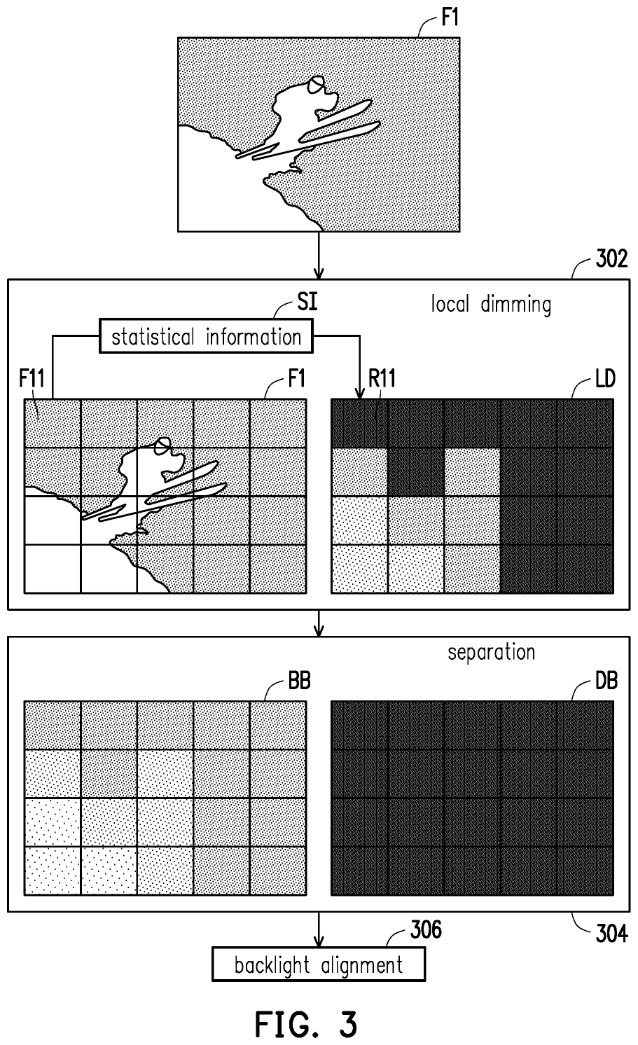

FIG. 3 illustrates a functional block diagram of a backlight control method in accordance with one of the exemplary embodiments of the disclosure. The steps of FIG. 3 could be implemented by the proposed display apparatus 100 as illustrated in FIG. 1.

Referring to FIG. 3 in conjunction with FIG. 1, the control circuit 114 would receive an input frame F1. In a local dimming process 302, the control circuit 114 would determine local dimming values LD of backlight blocks based on the statistical information SI of the corresponding image blocks of the input frame F1. As an example, an image block F11 would correspond to a backlight block R11. Next, in a separation process 304, the control circuit 114 would compute boosted backlight values BB and dimmed backlight values DB for the backlight blocks. Next, the control circuit 114 would start a backlight alignment process 306 to determine a delay time associated with a response time of the display panel 120, a first time period corresponding to the boosted backlight values BB, and a second time period corresponding to the dimmed backlight values DB. The driving circuit 116 would drive the backlight blocks based on the backlight alignment process 306.

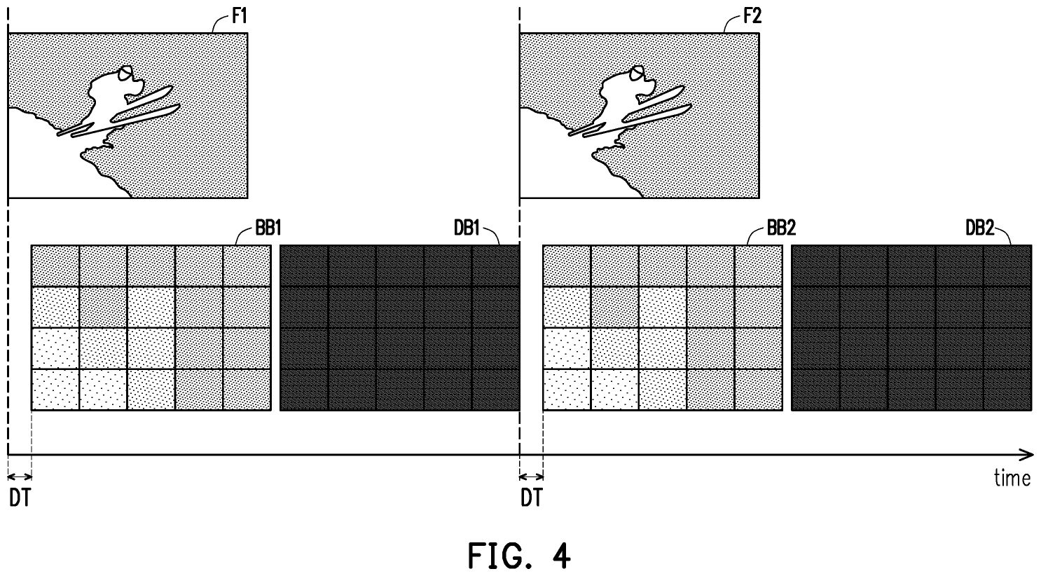

FIG. 4 illustrates a schematic diagram of a result of the proposed backlight control method in accordance with one of exemplary embodiments of the disclosure.

Referring to FIG. 4, after an input frame F1 is received, the backlight blocks would be driven with boosted backlight values BB1 for a first time period after a delay time DT for synchronization purposes and then driven with dimmed backlight values DB1 for a second time period. After a next input frame F2 is received, the backlight blocks would be driven with boosted backlight values BB2 for the first time period after the delay time DT and then driven with dimmed backlight values DB2 for the second time period.

In view of the aforementioned descriptions, the backlight control method for motion blur reduction, the backlight module and the display apparatus using the same proposed in the disclosure, by combining the backlight blinking technology with the backlight local dimming and boosting, the motion blur of the display panel would be removed without brightness loss.

No element, act, or instruction used in the detailed description of disclosed embodiments of the present application should be construed as absolutely critical or essential to the present disclosure unless explicitly described as such. Also, as used herein, each of the indefinite articles “a” and “an” could include more than one item. If only one item is intended, the terms “a single” or similar languages would be used. Furthermore, the terms “any of” followed by a listing of a plurality of items and/or a plurality of categories of items, as used herein, are intended to include “any of”, “any combination of”, “any multiple of”, and/or “any combination of” multiples of the items and/or the categories of items, individually or in conjunction with other items and/or other categories of items. Further, as used herein, the term “set” is intended to include any number of items, including zero. Further, as used herein, the term “number” is intended to include any number, including zero.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A backlight control method for motion blur reduction comprising:
receiving an input frame comprising a plurality of image blocks;
determining a brightness level of each of the image blocks to accordingly determine a local dimming value of each backlight block, wherein the backlight blocks respectively correspond to the image blocks;
computing a boosted backlight value and a dimmed backlight value for each of the backlight blocks according to the local dimming values; and
driving the backlight blocks according to the boosted backlight values and the dimmed backlight values in a time sequence.

2. The method according to claim 1, wherein the step of determining the brightness level of each of the image blocks to accordingly determine a local dimming value of each of the backlight blocks comprises:
for each of the image blocks:
computing the brightness level based on pixel values of pixels in the image block; and
determining the local dimming value of the backlight block corresponding to the image block.

3. The method according to claim 2, wherein the local dimming value of each of the image blocks is a weighted sum of a plurality of pieces of statistical information of the pixel values in the image block.

4. The method according to claim 1, wherein the step of computing the boosted backlight value and the dimmed backlight value for each of the backlight blocks according to the local dimming values comprises:
for each of the backlight blocks,
computing the boosted backlight value of the backlight block by boosting the corresponding local dimming value; and
computing the dimmed backlight value for each of the backlight block by lowering the corresponding local dimming value.

5. The method according to claim 1, wherein the step of driving the backlight blocks according to the boosted backlight values and the dimmed backlight values in the time sequence comprises:
for each of the backlight blocks:
designating a first time period and a second time period respectively corresponding to the boosted backlight value and the dimmed backlight value, wherein the sum of the first time period and the second time period is a frame display time of the frame; and
driving the backlight block with the boosted backlight value for the first time period followed by the dimmed backlight value for the second time period.

6. The method according to claim 5, wherein the first time period and the second time period are the same.

7. The method according to claim 5, wherein the first time period is shorter than the second time period.

8. The method according to claim 5, wherein for each of the backlight blocks, the step of driving the backlight block with the boosted backlight value for the first time period followed by the dimmed backlight value for the second time period further comprises:
estimating a display response time according to characteristics of a display panel;
driving the backlight block with the boosted backlight value for the first time period following a delay time associated with the display response time and followed by the dimmed backlight value for the second time period.

9. A backlight module comprising:
a light source, comprising a plurality of backlight blocks;
a control circuit, configured to receive an input frame comprising a plurality of image blocks respectively corresponding to the backlight blocks, determine brightness level of each of the image blocks to accordingly determine a local dimming value of each of the backlight blocks, and compute a boosted backlight value and a dimmed backlight value for each of the backlight blocks according to the local dimming values; and
a driving circuit, configured to drive the backlight blocks according to the boosted backlight values and the dimmed backlight values in a time sequence.

10. The backlight module according to claim 9, for each of the image blocks, the control circuit is configured to compute the brightness level based on pixel values of pixels in the image block and determine the local dimming value of the backlight block corresponding to the image block.

11. The backlight module according to claim 10, wherein the local dimming value of each of the image blocks is a weighted sum of a plurality of pieces of statistical information of the pixel values in the image block.

12. The backlight module according to claim 9, wherein for each of the backlight blocks, the control circuit is configured to compute the boosted backlight value of the backlight block by boosting the corresponding local dimming value and compute the dimmed backlight value for each of the backlight block by lowering the corresponding local dimming value.

13. The backlight module according to claim 9, wherein for each of the backlight blocks, the control circuit is configured to receive a first time period and a second time period designated corresponding to the boosted backlight value and the dimmed backlight value respectively, and the driving circuit is configured to drive the backlight block with the boosted backlight value for the first time period followed by the dimmed backlight value for the second time period.

14. The backlight module according to claim 13, wherein for each of the backlight blocks, the control circuit is configured to receive a display response time estimated according to characteristics of a display panel coupled to the backlight module, and the driving circuit is configured to drive the backlight block with the boosted backlight value for the first time period following a delay time associated with the display response time and followed by the dimmed backlight value for the second time period.

15. A display apparatus comprising:
a display panel; and
a backlight module, coupled to the display panel and comprising:
a light source, comprising a plurality of backlight blocks;
a control circuit, configured to receive an input frame comprising a plurality of image blocks respectively corresponding to the backlight blocks, determine brightness level of each of the image blocks to accordingly determine a local dimming value of each of the backlight blocks, and compute a boosted backlight value and a dimmed backlight value for each of the backlight blocks according to the local dimming values; and
a driving circuit, configured to drive the backlight blocks to project light onto the display panel according to the boosted backlight values and the dimmed backlight values in a time sequence.

16. The display apparatus according to claim 15, for each of the image blocks, the control circuit is configured to compute the brightness level based on pixel values of pixels in the image block and determine the local dimming value of the backlight block corresponding to the image block.

17. The display apparatus according to claim 16, wherein the local dimming value of each of the image blocks is a weighted sum of a plurality of pieces of statistical information of the pixel values in the image block.

18. The display apparatus according to claim 15, wherein for each of the backlight blocks, the control circuit is configured to compute the boosted backlight value of the backlight block by boosting the corresponding local dimming value and compute the dimmed backlight value for each of the backlight block by lowering the corresponding local dimming value.

19. The display apparatus according to claim 15, wherein for each of the backlight blocks, the control circuit is configured to receive a first time period and a second time period designated corresponding to the boosted backlight value and the dimmed backlight value respectively, and the driving circuit is configured to drive the backlight block with the boosted backlight value for the first time period followed by the dimmed backlight value for the second time period.

20. The display apparatus according to claim 19, wherein for each of the backlight blocks, the control circuit is configured to receive a display response time estimated according to characteristics of the display panel, and the driving circuit is configured to drive the backlight block with the boosted backlight value for the first time period following a delay time associated with the display response time and followed by the dimmed backlight value for the second time period.
